(19) United States
(12) Patent Application Publication
(10) Pub. No.: US 2012/0198131 A1
(43) Pub. Date: Aug. 2, 2012

(54) DATA WRITING METHOD FOR REWRITABLE NON-VOLATILE MEMORY, AND MEMORY CONTROLLER AND MEMORY STORAGE APPARATUS USING THE SAME

(75) Inventors: Kheng-Chong Tan, Miaoli (TW); Lai-Hock Chua, Hsinchu City (TW)

(73) Assignee: PHISON ELECTRONICS CORP., Miaoli (TW)

(21) Appl. No.: 13/094,829

(22) Filed: Apr. 27, 2011

(30) Foreign Application Priority Data
Jan. 31, 2011 (TW) 100103732

(51) Int. Cl. G06F 12/00

(52) U.S. Cl. 711/103; 711/E12.008

(57) ABSTRACT

A data writing method for writing data into physical blocks of a memory storage apparatus, and a memory controller and a memory storage apparatus using the same are provided, the physical blocks are grouped into a plurality of physical units. The method includes switching the speed mode of the memory storage apparatus into a first speed mode or a second speed mode according to a command and a work frequency received from a host system. The method also includes selecting a first writing mode to write the data into the physical units when the speed mode is the first speed mode. The method further includes selecting a second writing mode to write the data into the physical units when the speed mode is the second speed mode. Accordingly, the method can effectively shorten the time of executing a write command from the host system.

### CROSS-REFERENCE TO RELATED APPLICATION

This application claims the priority benefit of Taiwan application serial no. 100103732, filed on Jan. 31, 2011. The entirety of the above-mentioned patent application is hereby incorporated by reference herein and made a part of this specification.

### BACKGROUND

1. Technology Field

The present invention relates to a data writing method for a rewritable non-volatile memory module, and a memory controller and a memory storage apparatus using the same.

2. Description of Related Art

Along with the widespread of digital cameras, cell phones, and MP3 in recently years, the consumers' demand to storage media has increased drastically. Rewritable non-volatile memory is one of the most adaptable memories for electric products (e.g. notebooks) due to its characteristics such as data non-volatility, low power consumption, small volume, non-mechanical structure and high access speed. A solid state drive (SSD) is a storage apparatus adopting NAND flash memory as storage medium. Therefore, the flash memory industry has become a very important part of the electronic industry in recent years.

A flash memory storage system has a plurality of physical blocks, and each physical block has a plurality of physical pages, wherein data must be written orderly into a physical block according to the sequence of the physical pages in the physical block. Additionally, a physical page stored data thereon has to be erased before the physical page is used for writing with data again. In particular, a smallest unit for erasing data is one physical block, and a smallest unit for programming (also referred to writing) data is one physical page. Therefore, in the management of the flash memory storage system, the physical blocks are grouped into a data area and a free area.

The physical blocks of the data area are used for storing data written by the host system. To be specific, the memory management circuit transforms logical access addresses accessed by a host system into corresponding logical pages of logical blocks and maps the logical pages of the logical blocks to the physical pages of the physical blocks belonging to the data area. Namely, in the management for the flash memory module, the physical blocks of the data area are considered physical blocks that have stored data (e.g. data written by the host system). For example, the memory management circuit may use a logical block-physical block mapping table to record a mapping relationship between the logical blocks and the physical blocks of the data area, wherein logical pages of each logical block is mapped orderly to physical pages of a mapped physical block.

The physical blocks of the free area are used for substituting the physical blocks of the data area. To be specific, as described above, a physical page stored data thereon has to be erased before being written in again. Herein, the physical blocks of the free area are configured for substituting physical blocks originally mapped to the logical blocks. Accordingly, the physical blocks of the free area are either blank or available blocks (i.e., no data is recorded in these blocks or data recorded in these blocks is marked as invalid data). In particular, when a flash memory storage system is composed of a plurality of flash memory sub-modules, physical bocks belonging to different flash memory sub-modules are grouped into a plurality of physical units and the flash memory storage system is managed in units of each physical unit, thereby increasing the speed of accessing data. To be specific, one physical unit is composed of a plurality of physical blocks belonging to different flash memory sub-modules, and accordingly the physical blocks of the physical unit can be written data with a parallel manner or an interleave manner, thereby substantially increasing the speed of writing data.

As described above, the physical blocks of the data area and the free area are alternated to store data written by the host system. To make the host system to properly access the physical units that store data in an alternate mechanism, the flash memory storage system provides logical units and transforms the logical access addresses accessed by the host system to the logical pages of the logical blocks of the logical units. To be specific, the flash memory storage system may transform a logical access address accessed by the host system to a corresponding logical unit and record and update a mapping relationship between the logical units and the physical units of the data area in a logical unit-physical unit mapping table to reflect the alternation of the physical units. Thus, the host system simply accesses data based on the logical access addresses while the flash memory storage system reads data from or writes data into the mapped physical unit according to the logical unit-physical unit mapping table.

To be specific, when the host system is about to store new data into a logical access address, a control circuit of the flash memory storage system identifies a logical unit corresponding to the logical access address, get a physical unit from the free area and write the new data into the gotten physical unit (i.e. also referred to as “child physical unit”) to substitute a physical unit (also referred to as “mother physical unit”) originally mapped to the logical unit. Herein, the operation of making one logical unit to map to a mother physical unit and a child physical unit is referred to as “opening mother-child blocks. Afterward, when the host system is about to write data into another logical unit, the flash memory storage system may perform a data merging procedure to merge valid data of the logical unit currently mapped to the mother physical unit and the child physical unit (i.e. data belonging to this logical unit is merged into one physical unit).

For example, during the data merging procedure, the flash memory storage system copies valid data stored in the mother physical unit into the child physical unit and re-maps this logical unit to the child physical unit (i.e. the child physical unit is associated with the data area). Additionally, the flash memory storage system performs an erasing operation on the mother physical unit and associates the erased physical unit with the free area.

When the capacity of one logical unit is designed to become larger and the host system frequently updates data stored in a front portion of logical pages of the logical unit, the flash memory storage system needs to spend more time to perform such data merging procedure for executing next write command. Therefore, the time of executing the write command is delayed and the performance of the flash memory storage system is decreased. Therefore, how to shorten the time needed for executing a write command is one of the major subjects in the industry.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention relates to a data writing method, a memory controller and a memory storage apparatus, which are capable of applying corresponding data writing modes according to different data transmission speed modes and thereby shortening the time for executing a write command.

According to an exemplary embodiment of the present invention, a data writing method for writing data into a rewritable non-volatile memory module of a memory storage apparatus, wherein the rewritable non-volatile memory module includes a plurality of physical blocks, each of the physical blocks has a plurality of physical pages arranged with a sequence and the physical blocks are grouped into a plurality of physical units. The data writing method includes configuring a plurality of logical units for mapping to a portion of the physical units, wherein each of the logical units has a plurality of logical pages and a first logical unit among the logical units originally maps to a first physical unit among the physical units. The data writing method also includes receiving a command from a host system, obtaining a work frequency according to the command and switching a speed mode corresponding to the memory storage apparatus to a first speed mode or a second speed mode according to the work frequency. The data writing method also includes selecting a first writing mode to write the data into a second physical unit among the physical units when the speed mode is the first speed mode. The data writing method further includes selecting a second writing mode to write the data into the second physical unit among the physical units when the speed mode is the second speed mode.

According to an exemplary embodiment of the present invention, a memory controller for controlling a rewritable non-volatile memory module, wherein the rewritable non-volatile memory module includes a plurality of physical blocks, and each of the physical blocks has a plurality of physical pages arranged with a sequence. The memory controller includes a host interface, a memory interface and a memory management circuit. The host interface is configured for coupling to a host system and receiving data. The memory interface is configured for coupling to the rewritable non-volatile memory module. Herein the memory management circuit is coupled to the host interface and the memory interface. The memory management circuit is configured for grouping the physical blocks into a plurality of physical units and configuring a plurality of logical units for mapping to a portion of the physical units, wherein each of the logical units has a plurality of logical pages and a first logical unit among the logical units originally maps to a first physical unit among the physical units. Additionally, the memory management circuit receives a command from the host system, obtains a work frequency according to the command and switches a speed mode corresponding to the host interface to a first speed mode or a second speed mode according to the work frequency. Furthermore, the memory management circuit selects a first writing mode to write the data into a second physical unit among the physical units when the speed mode is the first speed mode. And, the memory management circuit selects a second writing mode to write the data into the second physical unit among the physical units when the speed mode is the second speed mode.

According to an exemplary embodiment of the present invention, a memory storage apparatus including a connector, a rewritable non-volatile memory module and a memory controller is provided. The connector is configured for coupling to a host system and receiving data. The rewritable non-volatile memory module includes a plurality of physical blocks, wherein each of the physical blocks has a plurality of physical pages arranged with a sequence. The memory controller is coupled to the connector and the rewritable non-volatile memory module. Herein, the memory controller groups the physical blocks into a plurality of physical units and configures a plurality of logical units for mapping to a portion of the physical units, wherein each of the logical units has a plurality of logical pages and a first logical unit among the logical units originally maps to a first physical unit among the physical units. Additionally, the memory controller receives a command from the host system, obtains a work frequency according to the command and switches a speed mode corresponding to the connector to a first speed mode or a second speed mode according to the work frequency. Furthermore, the memory controller selects a first writing mode to write the data into a second physical unit among the physical units when the speed mode is the first speed mode. And, the memory controller selects a second writing mode to write the data into the second physical unit among the physical units when the speed mode is the second speed mode.

Based on the above, in the exemplary embodiment of the present invention, the data writing method, the memory controller and the memory storage apparatus are capable of applying corresponding data writing mode according to different data transmission speed modes (e.g. Default Speed Mode or Ultra High Speed Mode) and thereby shortening the time for executing a write command and improving the performance of the memory storage apparatus.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

In order to make the aforementioned and other features and advantages of the present invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A is a block diagram of a host system and a memory storage apparatus according to a first exemplary embodiment of the present invention.

FIG. 1B is a diagram illustrating a computer, an input/output (I/O) device, and a memory storage apparatus according to the exemplary embodiment of the present invention.

FIG. 1C is a diagram of a host system and a memory storage apparatus according to another exemplary embodiment of the present invention.

FIG. 2 is a schematic block diagram of the memory storage apparatus in FIG. 1A.

FIG. 3 is a schematic block diagram of a memory controller according to the first exemplary embodiment of the present invention.

FIG. 4 is a schematic block diagram of a rewritable non-volatile memory module according to the first exemplary embodiment of the present invention.

FIG. 5A, FIG. 5B and FIG. 5C are diagrams of managing physical blocks according to the first exemplary embodiment of the present invention.

FIGS. 6˜8 are exemplary diagrams of writing data into the rewritable non-volatile memory module according to the first exemplary embodiment of the present invention.

FIG. 9 illustrates an example of executing a write command with a first writing mode according to the first exemplary embodiment of the present invention.

FIG. 10 illustrates an example of executing a write command with a second writing mode according to the first exemplary embodiment of the present invention.

FIG. 11 is a flowchart illustrating a data writing method according to the first exemplary embodiment of the present invention.

FIG. 12 is a schematic block diagram illustrating memory sub-modules of a rewritable non-volatile memory module according to the second exemplary embodiment of the present invention.

FIG. 13A and FIG. 13B are diagrams of managing physical blocks according to the second exemplary embodiment of the present invention.

FIG. 14 illustrates an example of executing a write command with the first writing mode according to the second exemplary embodiment of the present invention.

FIG. 15 illustrates an example of executing a write command with the second writing mode according to the second exemplary embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A,B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

### First Exemplary Embodiment

A memory storage apparatus (i.e. a memory storage system), typically, includes a rewritable non-volatile memory module and a controller (i.e., a control circuit). The memory storage apparatus is usually used together with a host system so that the host system can write data into or read data from the memory storage apparatus.

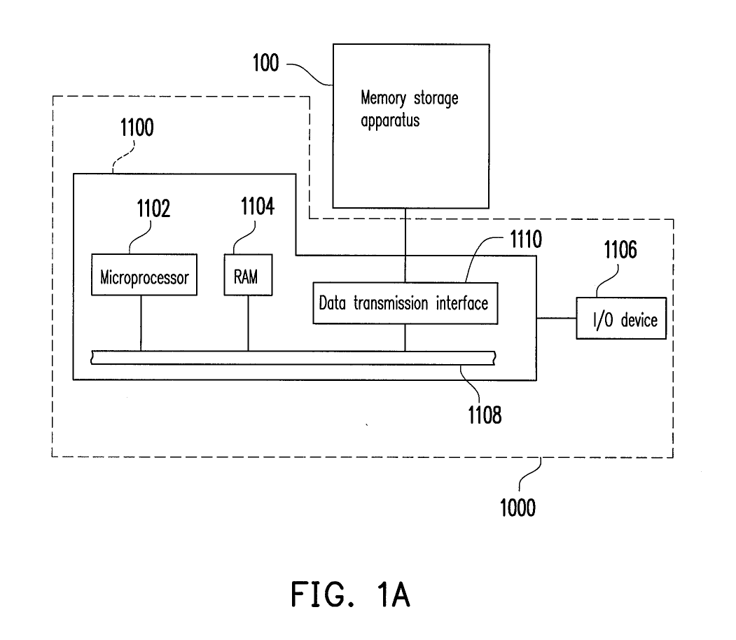

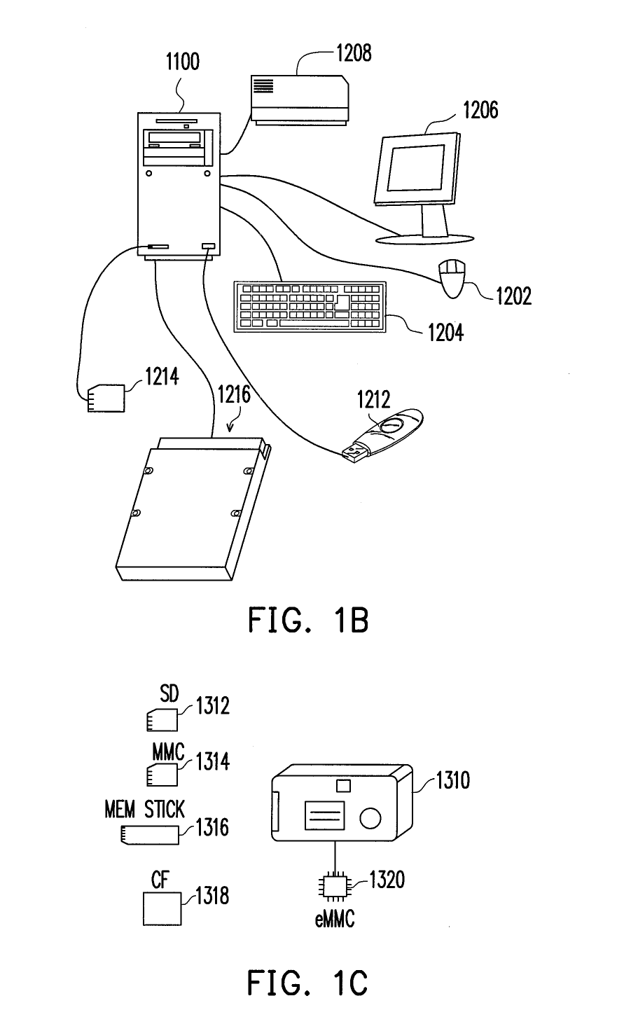

FIG. 1A is a block diagram of a host system and a memory storage apparatus according to the first exemplary embodiment of the present invention.

Referring to FIG. 1A, a host system 1000 includes a computer 1100 and an input/output (I/O) device 1106. The computer 1100 includes a microprocessor 1102, a random access memory (RAM) 1104, a system bus 1108 and a data transmission interface 1110. The I/O device 1106 includes a mouse 1202, a keyboard 1204, a display 1206, and a printer 1208 as shown in FIG. 1B. It should be noted that the devices in FIG. 1B do not limit the I/O device 1106; the I/O device 1106 may include other devices.

In the exemplary embodiment of the present invention, the memory storage apparatus 100 is coupled to the devices of the host system 1000 through the data transmission interface 1110. By using the microprocessor 1102, the random access memory (RAM) 1104 and the Input/Output (I/O) device 1106, the data can be write into the memory storage apparatus 100 or can be read from the memory storage apparatus 100. For example, the memory storage apparatus 100 may be a rewritable non-volatile memory storage apparatus, such as a flash drive 1212, a memory card 1214, or a solid state drive (SSD) 1216 shown in FIG. 1B.

Generally, the host system 1000 substantially could be any system capable of operating with the memory storage apparatus to store data. Even though the host system 1000 is described as a computer system in the present exemplary embodiment, in another exemplary embodiment of the present invention, the host system 1000 may also be a digital camera, a video camera, a communication device, an audio player, or a video player, and etc. For example, if the host system is a digital camera (video camera) 1310, the memory storage apparatus is then a SD card 1312, a MMC card 1314, a memory stick 1316, a CF card 1318 or an embedded storage device 1320 (as shown in FIG. 1C). The embedded storage device 1320 includes an embedded MMC (eMMC). It should be noted that the eMMC is directly coupled to the substrate of the host system.

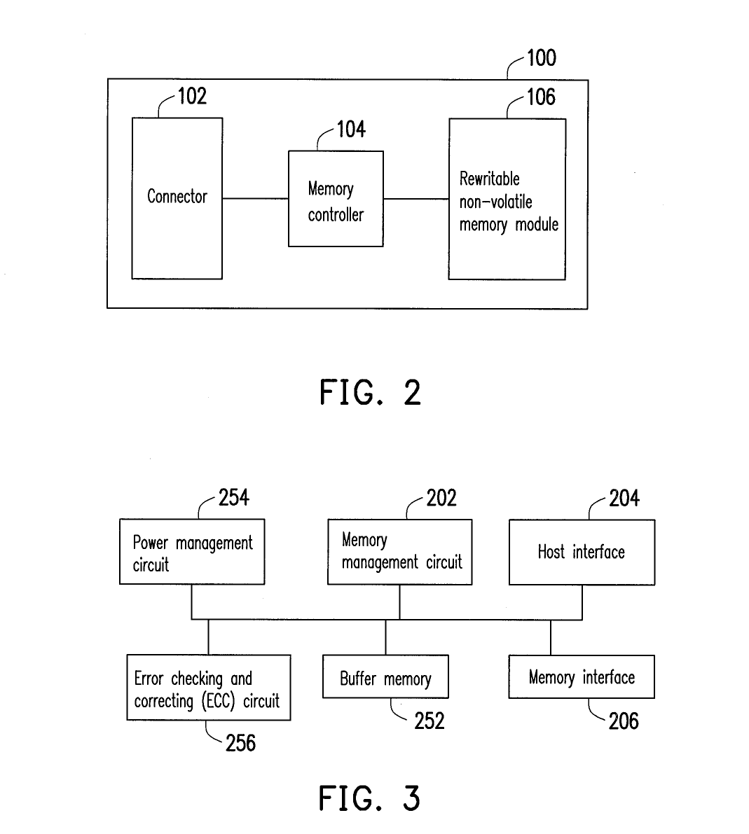

FIG. 2 is a schematic block diagram of the memory storage apparatus in FIG. 1A.

Referring to FIG. 2, the memory storage apparatus 100 includes a connector 102, a memory controller 104, and a rewritable non-volatile memory module 106.

In the present exemplary embodiment, the connector 102 complies with a secure digital (SD) interface standard. However, it should be noticed that the present invention is not limited to the aforementioned description and the connector 102 also can comply with an institute-of-electrical-and-electronic-engineers (IEEE) 1394 standard, a peripheral-component Interconnect-express (PCI Express) standard, a Serial Advanced Technology Attachment (SATA) standard, a universal serial bus (USB) standard, a memory stick (MS) interface standard, a multi-media-card (MMC) interface standard, a compact flash (CF) interface standard, an integrated-device-electronics (IDE) standard or other suitable standards.

The memory controller 104 executes a plurality of logic gates or control instructions implemented in a hardware form or a firmware form and performs various data operations such as data writing, reading, and erasing in the rewritable non-volatile memory module 106 according to commands from the host system 1000.

The rewritable non-volatile memory module 106 is coupled to the memory controller 104 and configured for storing data written by the host system 1000. According to the present exemplary embodiment, the rewritable non-volatile memory module 106 is a multi level cell (MLC) NAND flash memory module. However, the present invention is not limited thereto, and the rewritable non-volatile memory module 106 may also be a single level cell (SLC) NAND flash memory module, other flash memory module or other memory module having the same characteristic.

FIG. 3 is a schematic block diagram of a memory controller according to the first exemplary embodiment of the present invention.

Referring FIG. 3, the memory controller 104 includes a memory management circuit 202, a host interface 204 and a memory interface 206.

The memory management circuit 202 is configured for controlling the whole operation of the memory controller 104. To be specific, the memory management circuit 202 has a plurality of control instructions, and the control instructions are executed to perform a data writing operation, a data reading operation, a data erasing operation and so on when the memory storage apparatus 100 is in operation.

In the present exemplary embodiment, the control instructions of the memory management circuit 202 are implemented in a firmware form. For example, the memory management circuit 202 has a micro-processor unit (not shown) and a read-only memory (not shown), and these control instructions are burned in the read-only memory. When the memory storage apparatus 100 is in operation, the control instructions are executed by the micro-processor unit.

In another exemplary embodiment of the present invention, the control instructions of the memory management circuit 202 are stored in a specific area (for example, a system area) of the rewritable non-volatile memory module 106 as program codes. Additionally, the memory management circuit 202 may have a micro-processor unit (not shown), a read-only memory (not shown) and a random access memory (not shown). And, the read-only memory has a driver code, and when the memory controller 104 is enabled, the micro-processor unit executes the driver code to load the control instructions stored in the rewritable non-volatile memory module 106 into the random access memory of the memory management circuit 202. Then, the micro-processor unit runs these control instructions to perform the data writing operation, the data reading operation, the data erasing operation and so on. Additionally, the control instructions of the memory management circuit 202 may be implemented in a hardware form.

The host interface 204 is coupled to the memory management circuit 202, and configured for receiving and identifying commands and data from the host system 1000. Namely, the commands and data from the host system 1000 are transmitted to the memory management circuit 202 through the host interface 204. In the present exemplary embodiment, the host interface unit 204 complies with the SD standard. However, it should be understood that the present invention is not limited thereto, and the host interface 204 may be a PATA standard, an IEEE 1394 standard, a PCI express standard, a USB standard, a SATA standard, a MS standard, a MMC standard, a CF standard, an IDE standard, or other suitable data transmission standards.

The memory interface 206 is coupled to the memory management circuit 202 and configured for accessing the rewritable non-volatile memory module 106. Namely, data to be written into the rewritable non-volatile memory module 106 is converted by the memory interface 206 into a format acceptable to the rewritable non-volatile memory module 106.

In another exemplary embodiment of the present invention, the memory controller 104 still includes a buffer memory 252. The buffer memory 252 is coupled to the memory management circuit 202 and configured to temporarily store data and commands from the host system 1000 or data from the rewritable non-volatile memory module 106.

In another exemplary embodiment of the present invention, the memory controller 104 still includes a power management circuit 254. The power management circuit 254 is coupled to the memory management circuit 202 and configured for controlling the power of the memory storage apparatus 100.

In another exemplary embodiment of the present invention, the memory controller 104 still includes an error checking and correcting circuit 256. The error checking and correcting circuit 256 is coupled to the memory management circuit 202, and configured for executing an error checking and correcting procedure to ensure data accuracy. To be specific, when the memory management circuit 202 receives a write command from the host system 1000, the error checking and correcting circuit 256 generates an error checking and correcting (ECC) code for data corresponding to the write command, and the memory management circuit 202 writes the data and the corresponding ECC code into the rewritable non-volatile memory module 106. Subsequently, when the memory management circuit 202 reads the data from the rewritable non-volatile memory module 106, the memory management circuit 202 simultaneously reads the corresponding ECC code, and the error checking and correcting circuit 256 executes the ECC procedure for the read data based on the corresponding ECC code.

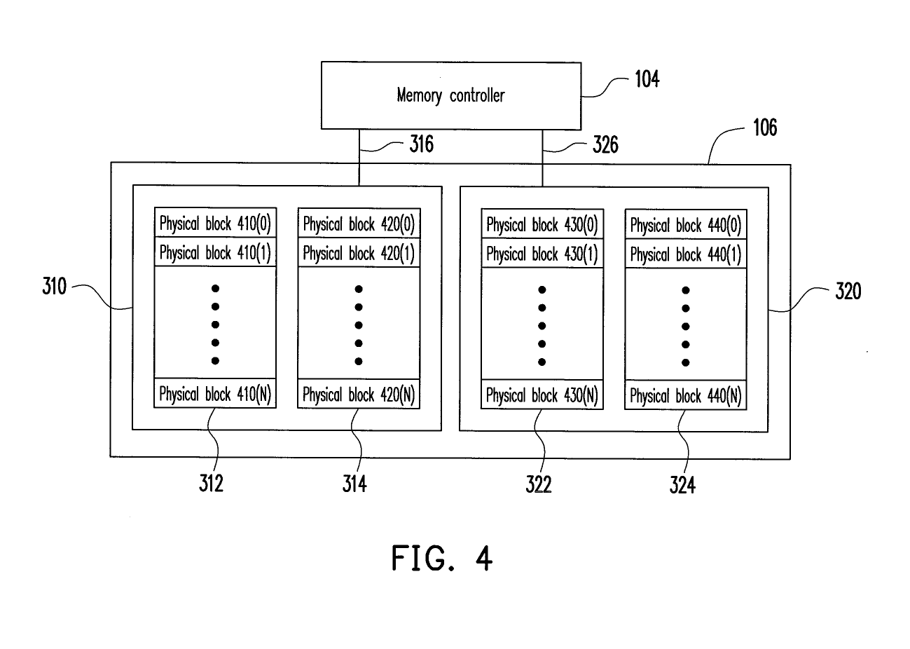

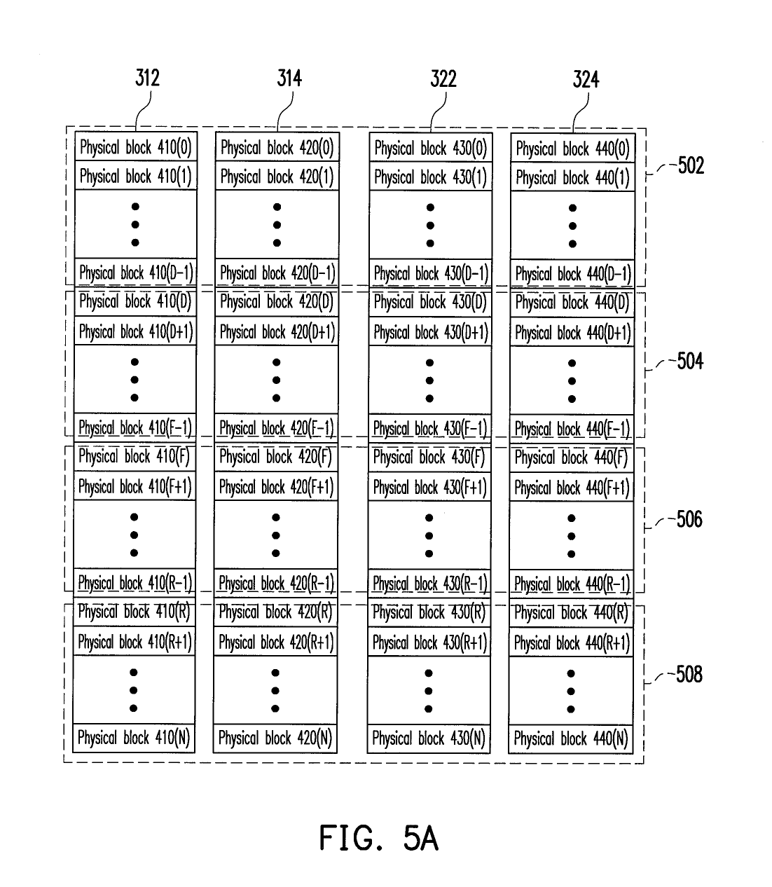

FIG. 4 is a schematic block diagram of a rewritable non-volatile memory module according to the first exemplary embodiment of the present invention.

Referring to FIG. 4, the rewritable non-volatile memory module 106 includes a first memory sub-module 310 and a second memory sub-module 320. For example, the first memory sub-module 310 and the second memory sub-module 320 respectively are memory dies. The first memory sub-module 310 has a first plane 312 and a second plane 314 and the second memory sub-module 320 has a first plane 322 and a second plane 324. The first plane 312 of the first memory sub-module 310 has physical blocks 410(0)˜410(N), the second plane 314 of the first memory sub-module 310 has physical blocks 420(0)˜420(N), the first plane 322 of the second memory sub-module 320 has physical blocks 430(0)˜430(N) and the second plane 324 of the second memory sub-module 320 has physical blocks 440(0)˜440(N).

For example, the first memory sub-module 310 and the second memory sub-module 320 are coupled to the memory controller 104 respectively via a data bus 316 and a data bus 326. Accordingly, the memory management circuit 202 may write data into the first memory sub-module 310 and the second memory sub-module 202 via the data bus 316 and the data bus 326 with a parallel manner.

However, it should be understood that in another exemplary embodiment the first memory sub-module 310 and the second memory sub-module 320 also can be coupled to the memory controller 104 only via one data bus. Herein, the memory management circuit 202 may write data into the first memory sub-module 310 and the second memory sub-module 202 via the single data bus with an interleave manner.

Each of the physical blocks of the first memory sub-module 310 and the second memory sub-module 320 has a plurality of physical pages, wherein the physical pages belonging to the same physical block can be written individually and must be erased simultaneously. For example, each physical block is composed of 128 physical pages. However, it should be noticed that the present invention is not limited thereto and each physical block may be composed of 64 physical pages, 256 physical pages or more physical pages.

In details, each physical block is the smallest erasing unit. Namely, each physical block contains the least number of memory cells that are erased together. And, one physical page is the smallest programming unit. Namely, each physical page is the smallest unit for writing data. However, it should be understood that in another exemplary embodiment, the smallest unit for writing data may be one sector or other size. Each physical page usually includes a user data bit area D and a redundant bit area R. The user data bit area D is used for storing user data, and the redundant bit area R is used for storing system data (for example, the ECC code).

It should be noted that the description of this embodiment is based on the example that the rewritable non-volatile memory module 106 includes 2 memory sub-modules, but the present invention is not limited thereto.

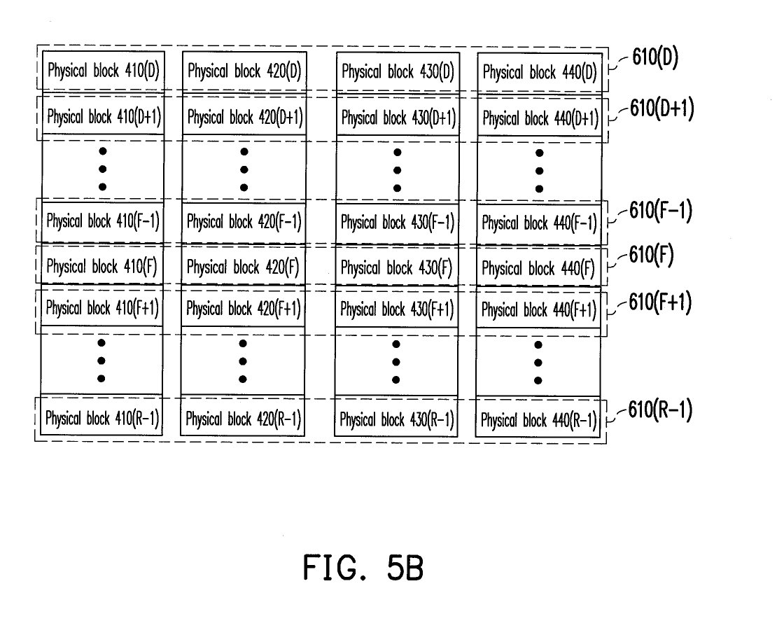

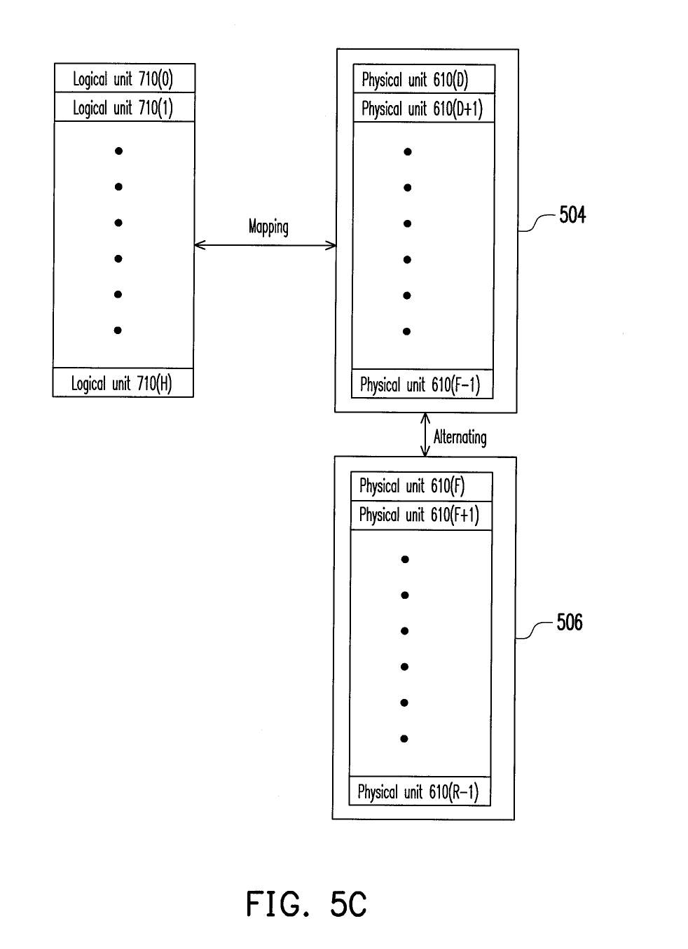

FIG. 5A, FIG. 5B and FIG. 5C are diagrams of managing physical blocks according to the first exemplary embodiment of the present invention.

Referring to FIG. 5A, the memory management circuit 202 of the memory controller 104 logically groups the physical blocks 410(0)˜410(N), 420(0)˜420(N), 430(0)˜430(N) and 440(0)˜440(N) into a system area 502, a data area 504, a free area 506 and a replacement area 508.

The physical blocks logically belonging to the system area 502 are used for recording system data. For example, such system data includes information related to the manufacturer and a model of the rewritable non-volatile memory module, the number of the physical blocks in the rewritable non-volatile memory module, the number of the physical pages in each physical block, and so forth.

The physical blocks logically belonging to the data area 504 and the free area 506 are used for storing data written by the host system 1000. To be specific, the physical blocks of the data area 504 are physical blocks which have been used for storing data, and the physical blocks of the free area 506 are physical blocks which are used for substituting the physical blocks of the data area 504. That is, when receiving write commands and data to be written from the host system 1000, the memory management circuit 202 gets a physical block from the free area 506 and writes the data into the gotten physical block for substituting the physical block of the data area 504.

The physical blocks logically belonging to the replacement area 508 are physical blocks for a bad physical block replacement procedure to replace damaged bad physical blocks. To be specific, if there are still normal physical blocks in the replacement area 508 and a physical block is damaged, the memory management circuit 202 gets a normal physical block from the replacement area 508 for replacing the damaged physical block.

Referring to FIG. 5B, when the memory storage apparatus 100 has manufactured and is enabled initially, the memory management circuit 202 initially configures several physical blocks (e.g. the physical blocks 410(D)˜410(F−1), 420(D)˜420(F−1), 430(D)˜430(F−1) and 440(D)˜440(F−1)) to the data area 504 according to the designed capacity of the memory storage apparatus 100, even though these physical blocks have not stored data.

In particular, the memory management circuit 202 groups the physical blocks belonging to the data area 504 and the free area 506 into a plurality of physical units and manages the physical blocks in unit of each physical unit.

For example, the physical blocks 410(D)˜410(F−1), 420(D)˜420(F−1), 430(D)—430(F−1) and 440(D)′˜440(F−1) of the data area 504 are respectively grouped into physical units 610(D)˜610(F−1) and the physical blocks 410(F)˜410(R−1), 420(F)˜420(R−1), 430(F)˜430(R−1) and 440(F)˜440(R−1) of the free area 506 are respectively grouped into physical units 610(F)˜610(R−1).

In particular, in the present exemplary embodiment, because one physical unit is composed of physical blocks belonging to the two memory sub-modules, the memory management circuit 202 may use the parallel manner to write data into the first memory sub-module 310 and the second memory sub-module 320 when executing a write command, thereby increasing the speed of writing data. Additionally, in the present exemplary embodiment, because the physical blocks belonging to the same memory sub-module in one physical unit belong to different planes, the memory management circuit 202 may use a two plane program command to write data into two physical pages together.

Additionally, the memory management circuit 202 configures logical units 710(0)˜710(H) for mapping the physical units of the data area 504. Herein, the memory management circuit 202 may maintain a logical unit-physical unit mapping table for recoding a mapping relationship between the logical units 710(0)˜710(H) and the physical units of the data area 504. To be specific, when the host system 1000 is about to access data at a logical access address, the memory management circuit 202 identifies a logical page corresponding to the logical access address and a logical unit that the logical page belongs to, and therefore accesses the data at a physical page of a physical unit mapped to the logical unit based on the logical unit-physical unit mapping table.

After the foregoing initial procedure, the memory store apparatus 100 could receive a write command from the host system 1000 and write data.

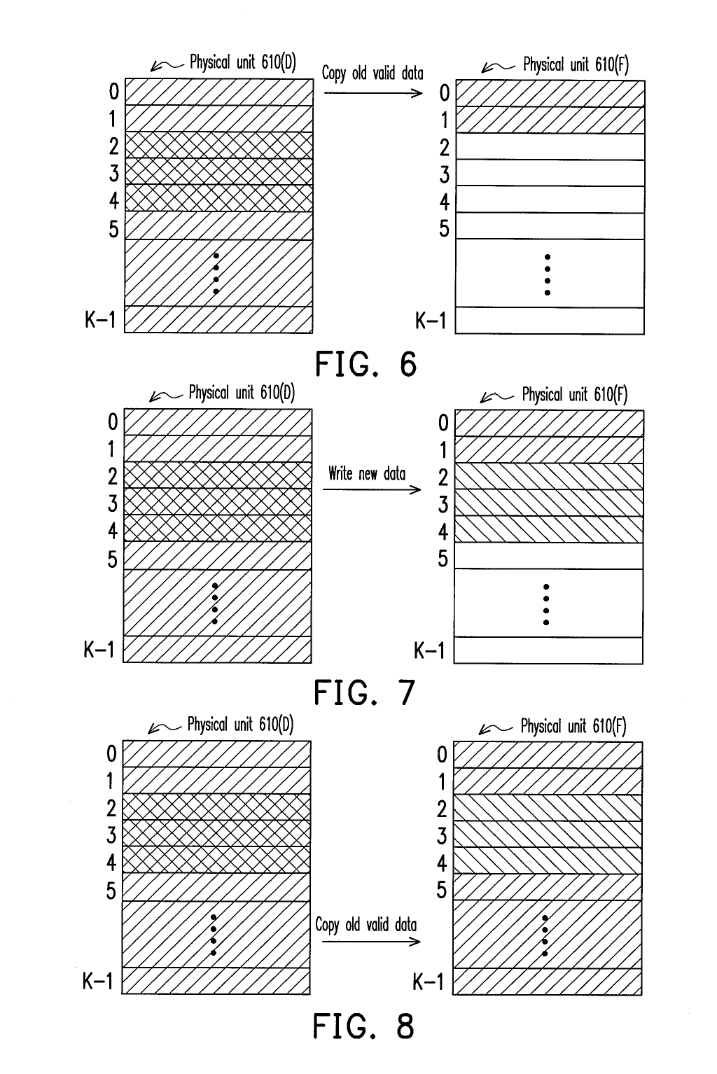

FIGS. 6˜8 are exemplary diagrams of writing data into the rewritable non-volatile memory module according to the first exemplary embodiment of the present invention.

Referring to FIGS. 6˜8, for example, when the logical unit 710(0) currently maps to the physical unit 610(D) and the memory controller 104 receives a write command from the host system 1000 for writing data into a logical page belonging to the logical unit 710(0), the memory management circuit 202 identifies that the logical unit 710(0) currently maps to the physical unit 610(D) based on the logical unit-physical unit mapping table and gets the physical unit 610(F) from the free area 504 as a substitute physical unit for substituting the physical unit 610(D). However, the memory management circuit 202 does not instantly move all the valid data in the physical unit 610(D) into the physical unit 610(F) and erase the physical unit 610(D) during executing the write command to write the data into the physical unit 610(F). To be specific, the memory management circuit 202 copies the valid data before the physical page for writing the new data in the physical unit 610(D) (i.e., the 0^{th} physical page and the 1^{st} physical page of the physical unit 610(D)) to the 0^{th} physical page and the 1^{st} physical page of the physical unit 610 (F) (as shown in FIG. 6) and writes the new data into the 2^{nd}˜4^{th} physical pages of the physical unit 610(F) (as shown in FIG. 7).

At this time, the memory management circuit 202 has completed the writing operation (i.e., the write command has been finished). Because the valid data in the physical unit 610 (D) may become invalid during a next operation (for example, next write command), instantly moving all the valid data in the physical unit 610(D) to the physical unit 610(F) may become meaningless. Additionally, because data must be written orderly into the physical pages of the physical units, the memory management circuit 202 only moves valid data (i.e. data stored in the 0^{th} physical page and the 1^{st} physical page of the physical unit 610(D)) before the physical page to be written and does not move other valid data (i.e. data stored in the 5^{th}˜(K−1)^{th} physical pages of the physical unit 610(D)).

In the present exemplary embodiment, the operations shown in FIG. 6 and FIG. 7 are referred to as “opening mother-child blocks” and the original physical unit (e.g. the physical unit 610(D)) is referred to as a “mother physical unit” and the substitute physical unit (e.g. the physical unit 610(F)) is referred to as a “child physical unit”.

Thereafter, the memory management circuit 202 will integrate the physical unit 610(D) and the physical unit 610(F) into a single physical unit when the contents of the two are to be actually combined, so that the efficiency of using physical units can be improved. Herein, the operations of integrating the physical units are also referred to as “closing mother-child blocks”. For example, as shown in FIG. 8, when closing the mother-child blocks, the memory management circuit 202 copies rest of the valid data in the physical unit 610(D) (i.e. data stored in the 5^{th}˜(K−1)^{th} physical pages of the physical unit 610(D)) to the 5^{th}˜(K−1)^{th} physical pages of the physical unit 610(F), and then erases the physical unit 610(D) and associates the physical unit 610(D) with the free area 506. Meanwhile, the physical unit 610(F) is associated with the data area 504. Namely, the memory management circuit 202 re-maps the logical unit 710(0) to the physical unit 610 (F) in the logical unit-physical unit mapping table. Additionally, in the present exemplary embodiment, the memory management circuit 202 establishes a free area physical unit table (not shown) for recording the physical units currently associated with the free area 506. It should be noted that the physical units of the free area 506 is limited. Accordingly, during the operation of the memory storage apparatus 100, the number of the currently-opened mother-child block sets is limited. Herein, one currently-opened mother-child block set contains one mother unit and at least one child unit that are corresponding to one logical unit. Thus, when the memory storage apparatus 100 receives a write command from the host system 1000, if the number of currently-opened mother-child sets reaches an upper limit value, the memory management circuit 202 will close at least one of mother-child block set to execute the write command.

For example, in a case where the memory storage apparatus is a SD memory card, the upper limit value is set as 1. For example, when it is under the status shown in FIG. 7 and the memory controller 104 receives a write command from the host system 1000 for writing data into the logical access address belonging to the logical unit 710(1), the memory management circuit 202 first performs the operation of closing mother-child blocks (as shown in FIG. 8) and then performs the operation of opening mother-child blocks (as shown in FIGS. 6˜7), thereby completing the data writing operation.

In the present exemplary embodiment, the memory controller 104 obtains a work frequency adapted for the connector 102 from the host system 1000. Specifically, when the memory storage apparatus 100 is coupled to the host system 1000, the host system 1000 sends a command to the memory storage apparatus 100 to query basic information about the memory storage apparatus 100. Then, the memory controller 104 transmits the basic information thereof to the host system 1000, wherein the basic information contains one or more writing frequencies supported by the connector 102 and the host interface 204 of the memory storage apparatus 100. After that, the host system 1000 gives a command to the memory storage apparatus 100 to indicate which writing frequency is applied. Then, the memory controller 104 sets a flag corresponding to the writing frequency indicated by the host system 1000 as a corresponding value (e.g. ‘1’). Nevertheless, it should be understood that the present invention is not limited thereto and the flag may be any value for indicating which writing frequency is applied. Accordingly, when the host system 1000 is about to write data, the memory controller 104 writes the data into the physical units according to the set flag.

In details, the host system may give a command to indicate the memory controller 104 to use a first speed mode or a second speed mode based on the corresponding writing frequency.

For example, in the case where the host interface 204 is SD interface, the first speed mode is the Default Speed Mode and the second speed mode is the Ultra High Speed Mode.

In particular, when the speed mode is the first speed mode, the memory management circuit 202 uses a first writing mode to write data and when the speed mode is the second speed mode, the memory management circuit 202 uses a second writing mode to write data.

To be specific, a pattern of storing data by the host system 1000 is various according to different speed modes. For example, in the case where the memory storage apparatus 1000 is a SD memory card, when the host system uses the Default Speed Mode to store data, the size of the written data is smaller than or equal to a half of the capacity of one physical unit. And, when the host system uses the Ultra high Speed Mode to store data, the size of the written data is larger than a half of the capacity of one physical unit. In the present exemplary embodiment, the memory management circuit 202 uses a corresponding writing speed to optimize the speed of writing data based on a speed mode applied by the host system 1000.

In the first writing mode, when executing a write command to write data belonging to a first half of the logical pages of a logical unit, the memory management circuit 202 synchronously performs the data merging procedure for a later half of the logical pages of the logical unit. To be specific, when the host system 1000 is about to store data into the 0^{th}˜(m−1)^{th} logical pages, the memory management circuit 202 writes the data belonging to the 0^{th}˜(m−1)^{th} logical pages while moves valid data belonging to the m^{th}˜(K)^{th} logical pages. Herein, m is calculated according to a formula (I):

m=K/2+1 (1),

wherein K represents the number of the logical pages of the logical unit.

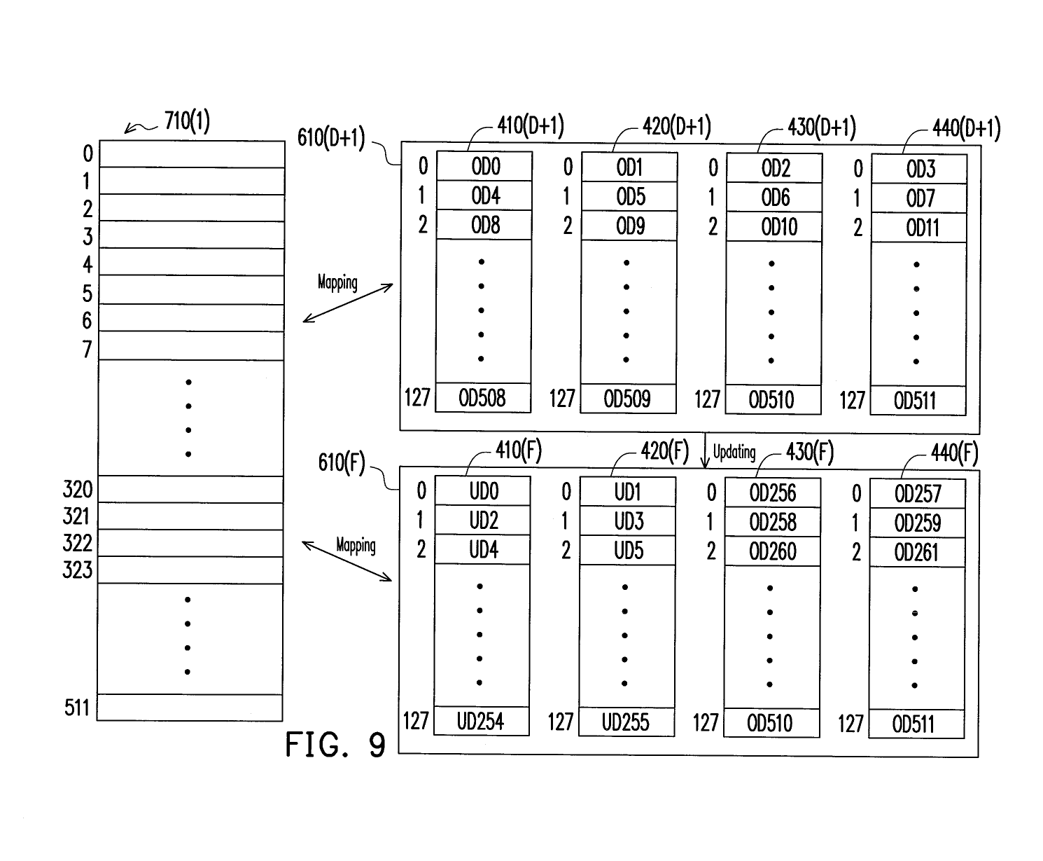

FIG. 9 illustrates an example of executing a write command with a first writing mode according to the first exemplary embodiment of the present invention. In order to explain conveniently, it is assumed that each physical block has 128 physical pages (i.e. 0^{th}˜127^{th} physical pages) and accordingly each logical unit has 512 logical pages (i.e. 0^{th}˜511^{th} logical pages).

Referring to FIG. 9, for example, when the physical unit 610(D+1) has stored page data OD0˜OD511 belonging to the 0^{th}˜511^{th} logical pages of the logical unit 710(1) and the host system 1000 is about to store update data belonging to the 0^{th}˜255^{th} logical pages of the logical unit 710(1), the memory management circuit 202 of the memory controller 104 identifies that the logical unit 710(1) currently maps the physical unit 610(D+1), gets the physical unit 610(F) from the free area 506, arranges the update data into corresponding page data UD0˜UD255 and orderly writes the page data UD0˜UD255 into the physical pages of the physical blocks 410 (F) and 420(F) of the physical unit 610(F) (i.e. the operations of opening mother-child blocks shown in FIGS. 6 and 7). In particular, because the memory sub-module that the physical blocks 410(F) and 420(F) belong to and the memory sub-module that the physical blocks 430(F) and 440(F) belong to are different, the memory management circuit 202 may move un-updated page data belonging to the logical unit 710(1) from the physical unit 610(D+1) to the physical blocks 430 (F) and 440(F) of the physical unit 610(F) with the parallel manner.

To be specific, the memory management circuit 202 uses the two plane program command to write the page data UD0˜UD1 belonging to the 0^{th}˜1^{st} logical pages of the logical unit 710(1) into the 0^{th} physical page of the physical block 410(F) and the 0^{th} physical page of the physical block 420(F), and moves the page data OD256˜OD257 belonging to the 256^{th}˜257^{th} logical pages of the logical unit 710(1) from the physical unit 610(D+1) to the 0^{th} physical page of the physical block 430(F) and the 0^{th} physical page of the physical block 440(F). That is, during such programming, the page data UD0 belonging to the 0^{th} logical page of the logical unit 710(1) is written into the 0^{th} physical page of the physical block 410(F) and the page data UD1 belonging to the 1^{st} logical page of the logical unit 710(1) is written into the 0^{th} physical page of the physical block 420(F). And, at the same time, the page data OD256 belonging to the 256^{th} logical page of the logical unit 710(1) is moved to the 0^{th} physical page of the physical block 430(F) and the page data OD257 belonging to the 257^{th} logical page of the logical unit 710(1) is moved to the 0^{th} physical page of the physical block 440(F).

Subsequently, the memory management circuit 202 uses the two plane program command to write the page data UD2˜UD3 belonging to the 2^{nd}˜3^{rd} logical pages of the logical unit 710(1) into the 1^{st} physical page of the physical block 410(F) and the 1^{st} physical page of the physical block 420(F), and moves the page data OD258˜OD259 belonging to the 258^{th}˜259^{th} logical pages of the logical unit 710(1) from the physical unit 610(D+1) to the 1^{st} physical page of the physical block 430(F) and the 1^{st} physical page of the physical block 440(F).

By the same token, finally, the memory management circuit 202 uses the two plane program command to write the page data UD254˜UD255 belonging to the 255^{th} logical pages of the logical unit 710(1) into the 127^{th} physical page of the physical block 410(F) and the 127^{th} physical page of the physical block 420(F), and moves the page data OD510˜OD511 belonging to the 510^{th}˜511^{th} logical pages of the logical unit 710(1) from the physical unit 610(D+1) to the 127^{th} physical page of the physical block 430(F) and the 127^{th} physical page of the physical block 440(F).

And, when the host system 1000 subsequently gives a write command for storing data into another logical unit, because the valid data that is stored in the physical unit 610(D+1) and belongs to the 256^{th}˜511^{th} logical pages of the logical unit 710(1) has moved to the physical unit 610(F), the memory management circuit 202 directly executes the next write command after re-mapping the logical unit 710(1) to the physical unit 610(F) in the logical unit-physical unit mapping table (i.e. the physical unit 610(F) is associated with the data area 504) and associating the physical unit 610(D+1) with the free area 506. That is, the operations of closing mother-child blocks are performed.

In the first writing mode, when executing a next write command, the time for performing the data merging procedure can be reduced by simultaneously moving un-updated valid data during a current write command. Therefore, when the host system 1000 always stores data having the size that is smaller than a half of the capacity of one physical unit (e.g. the host system 1000 uses the Default Speed Mode to store data), the time for executing a write command can be shortened through the first writing mode.

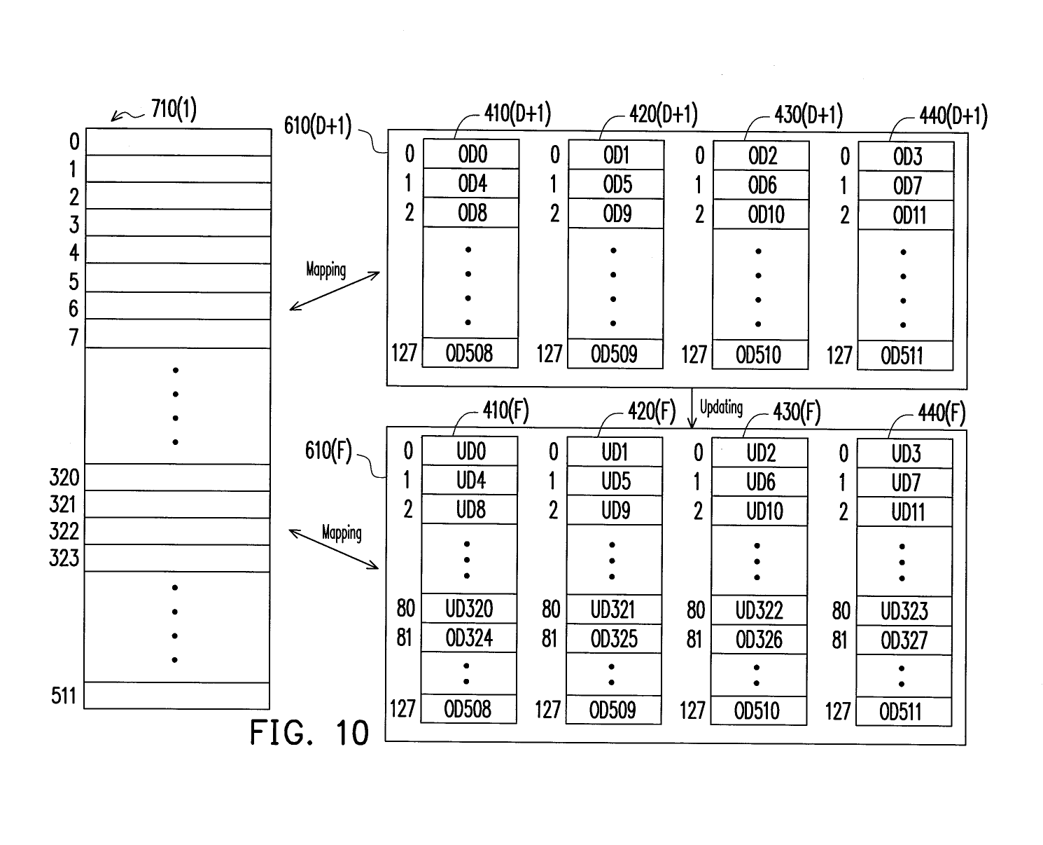

FIG. 10 illustrates an example of executing a write command with a second writing mode according to the first exemplary embodiment of the present invention. In order to explain conveniently, it is assumed that each physical block has 128 physical pages (i.e. 0^{th}˜127^{th} physical pages) and accordingly each logical unit has 512 logical pages (i.e. 0^{th}˜511^{th} logical pages).

Referring to FIG. 10, for example, when the physical unit 610(D+1) has stored page data OD0˜OD511 belonging to the 0^{th}˜511^{th} logical pages of the logical unit 710(1) and the host system 1000 is about to store update data belonging to the 0^{th}˜323^{th} logical pages of the logical unit 710(1), the memory management circuit 202 of the memory controller 104 identifies that the logical unit 710(1) currently maps the physical unit 610(D+1), gets the physical unit 610(F) from the free area 506, arranges the update data into corresponding page data UD0˜UD323 and orderly writes the page data UD0˜UD323 into the physical pages of the physical blocks 410 (F), 420(F), 430(F) and 440(F) of the physical unit 610(F) (i.e. the operations of opening mother-child blocks shown in FIGS. 6 and 7).

To be specific, the memory management circuit 202 uses the two plane program command as well as the parallel manner to write the page data UD0˜UD3 belonging to the 0^{th}˜3^{rd} logical pages of the logical unit 710(1) into the 0^{th} physical page of the physical block 410(F), the 0^{th} physical page of the physical block 420(F), the 0^{th} physical page of the physical block 430(F) and the 0^{th} physical page of the physical block 440(F). That is, during such programming, the page data UD0 belonging to the 0^{th} logical page of the logical unit 710(1) is written into the 0^{th} physical page of the physical block 410(F), the page data UD1 belonging to the 1^{st} logical page of the logical unit 710(1) is written into the 0^{th} physical page of the physical block 420(F), the page data UD2 belonging to the 2^{nd} logical page of the logical unit 710(1) is written into the 0^{th} physical page of the physical block 430(F) and the page data UD3 belonging to the 3^{rd} logical page of the logical unit 710(1) is written into the 0^{th} physical page of the physical block 440(F).

Subsequently, the memory management circuit 202 uses the two plane program command as well as the parallel manner to write the page data UD4˜UD7 belonging to the 4^{th}˜7^{th} logical pages of the logical unit 710(1) into the 1^{st} physical page of the physical block 410(F), the 1^{st} physical page of the physical block 420(F), the 1^{st} physical page of the physical block 430(F) and the 1^{st} physical page of the physical block 440(F).

By the same token, finally, the memory management circuit 202 uses the two plane program command as well as the parallel manner to write the page data UD320˜UD323 belonging to the 320^{th}˜323^{rd} logical pages of the logical unit 710(1) into the 80^{th} physical page of the physical block 410(F), the 80^{th} physical page of the physical block 420(F), the 80^{th} physical page of the physical block 430(F) and the 80^{th} physical page of the physical block 440(F).

And, when the host system 1000 subsequently gives a write command for storing data into another logical unit, before executing the write command, the memory management circuit 202 moves valid data belonging to the 324^{th}˜511^{th} logical pages of the logical unit 710(1) from the physical unit 610(D+1) to the corresponding physical pages of the physical unit 610(F), re-maps the logical unit 710(1) to the physical unit 610(F) in the logical unit-physical unit mapping table (i.e. the physical unit 610(F) is associated with the data area 504) and associates the physical unit 610(D+1) with the free area 506 (i.e. similar to the operations of closing mother-child blocks shown in FIG. 8).

In the second writing mode, continuous logical pages of one logical unit are dispersedly mapped to physical pages belonging to different memory sub-modules. Therefore, when the host system 1000 writes large amounts of data into continuous logical pages, those data can be written with the parallel manner into the physical pages, thereby shortening the time for writing data.

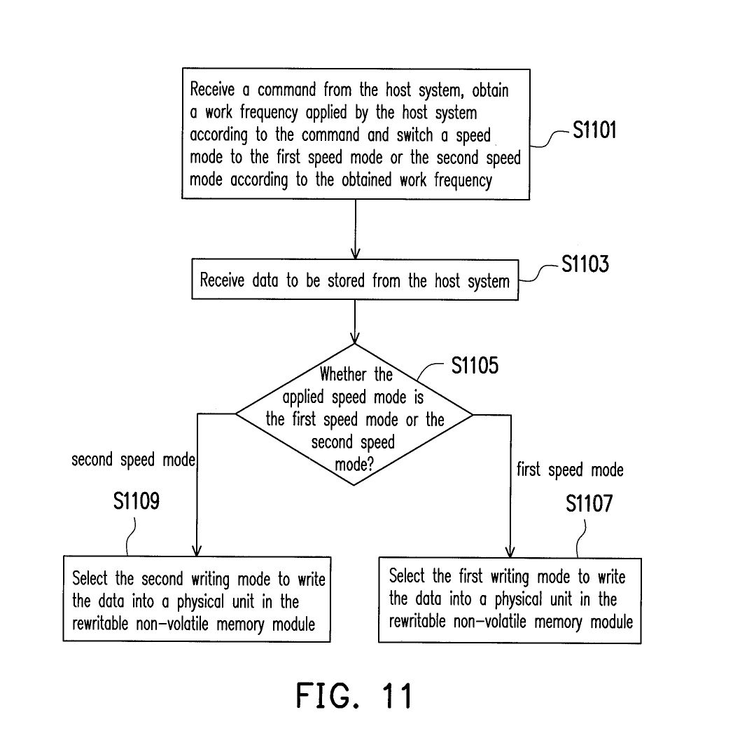

FIG. 11 is a flowchart illustrating a data writing method according to the first embodiment of the present invention.

Referring to FIG. 11, in step S1101, the memory controller 104 receives a command from the host system, obtains a work frequency applied by the host system 1000 according to the command and switches a speed mode to the first speed mode or the second speed mode according to the obtained work frequency. Then, in step S1103, the memory controller 104 receives data to be stored from the host system 1000.

In step S1105, the memory controller 104 determines whether the applied speed mode is the first speed mode or the second speed mode.

If the speed mode is the first speed mode, in step S1107, the memory controller 104 selects the first writing mode to write the data into a physical unit in the rewritable non-volatile memory module 106. To be specific, in step S1107, the memory controller 104 identifies a logical unit (hereinafter referred to as “the first logical unit”) corresponding to the data to be stored and a physical unit (hereinafter referred to as ‘the first physical unit”) mapped to the first logical unit, gets one physical unit (hereinafter referred to as “the second physical unit”) from the free area 506 and uses the parallel manner to write the page data to be written and un-updated valid data into the second physical unit, such as the operations shown in FIG. 9.

If the speed mode is the second speed mode, in step S1109, the memory controller 104 selects the second writing mode to write the data into a physical unit in the rewritable non-volatile memory module 106. To be specific, in step S1109, the memory controller 104 identifies a logical unit (hereinafter referred to as “the first logical unit”) corresponding to the data to be stored and a physical unit (hereinafter referred to as ‘the first physical unit”) mapped to the first logical unit, gets one physical unit (hereinafter referred to as “the second physical unit”) from the free area 506 and uses the parallel manner to write the page data to be written, such as the operations shown in FIG. 10.

### Second Exemplary Embodiment

A memory storage apparatus and a host system in the second exemplary embodiment essentially are similar to the memory storage apparatus and the host system in the first exemplary embodiment, wherein the difference is that memory sub-modules of a rewritable non-volatile memory module are respectively composed of a single plane.

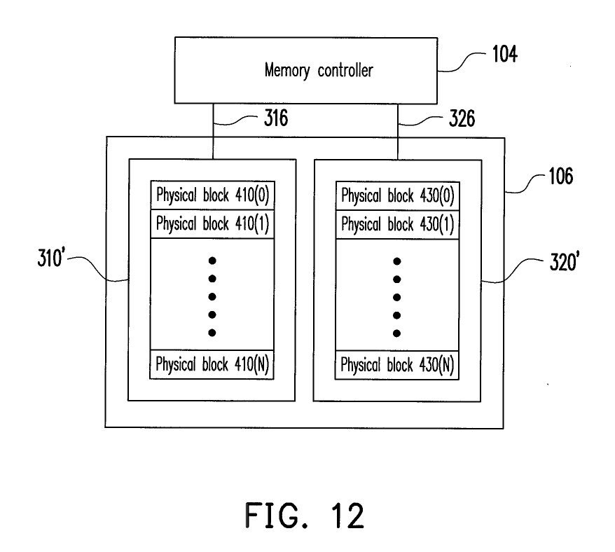

FIG. 12 is a schematic block diagram illustrating memory sub-modules of a rewritable non-volatile memory module according to the second exemplary embodiment of the present invention.

Referring to FIG. 12, the rewritable non-volatile memory module 106′ includes a first memory sub-module 310′ and a second memory sub-module 320′. For example, the first memory sub-module 310′ and the second memory sub-module 320′ respectively are memory dies. The first memory sub-module 310′ has the physical blocks 410(0)˜410(N) belonging to the same plan and the second memory sub-module 320′ has the physical blocks 430(0)˜430(N) belonging to the same plan. For example, the first memory sub-module 310′ and the second memory sub-module 320′ are coupled to the memory controller 104 respectively via the data bus 316 and the data bus 326. Accordingly, the memory management circuit 202 may write data into the first memory sub-module 310′ and the second memory sub-module 320′ via the data bus 316 and the data bus 326 with the parallel manner

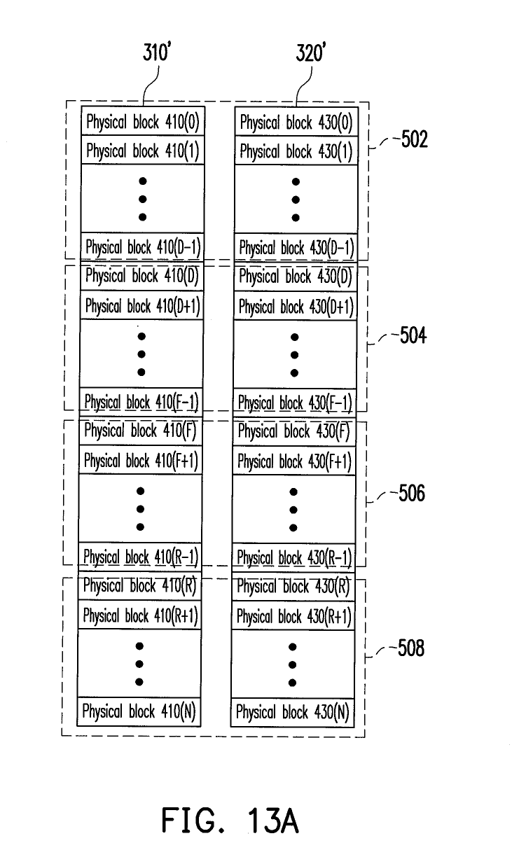

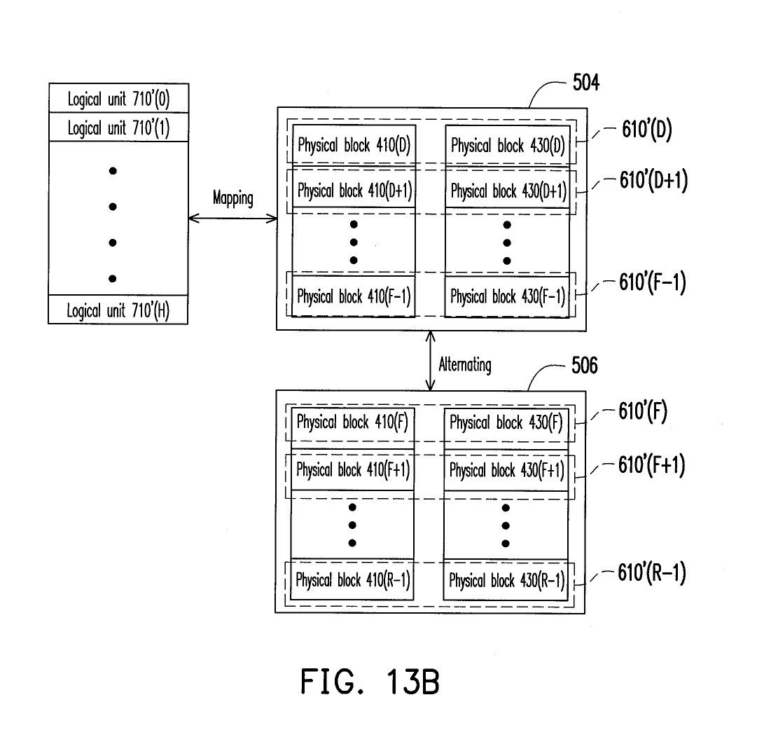

FIG. 13A and FIG. 13B are diagrams of managing physical blocks according to the second exemplary embodiment of the present invention.

Referring to FIG. 13A, the memory management circuit 202 of the memory controller 104 logically groups the physical blocks 410(0)˜410(N) and 430(0)˜430(N) into the system area 502, the data area 504, the free area 506 and the replacement area 508.

Referring to FIG. 13B, the memory management circuit 202 groups the physical blocks belonging to the data area 504 and the free area 506 into a plurality of physical units and manages the physical blocks in unit of each physical unit. For example, the physical blocks 410(D)˜410(F−1) and 430(D)˜430(F−1) of the data area 504 are respectively grouped into physical units 610′(D)-610′(F−1), and the physical blocks 410(F)˜410(R−1) and 430(F)˜430(R−1) of the free area 506 are respectively grouped into physical units 610′(F)˜610′(R−1). In the present exemplary embodiment, the memory management circuit 202 may write data into the first memory sub-module 310′ and the second memory sub-module 320′ with the parallel manner when executing a write command, thereby increasing the speed of writing data. Additionally, similar to the first exemplary embodiment, the memory management circuit 202 configures logical unit 710′(0)˜710′(H) for mapping the physical units of the data area 504 and alternately uses the physical units to write data to be stored in the logical unit 710′(0)˜710′(H) by host system 1000, such as operations shown in FIGS. 6-8.

The same as the first exemplary embodiment, in the second exemplary embodiment, the memory controller 104 detects a work frequency between the data transmission interface 1110 and the connector 102. And, when the speed mode corresponding to the connector 102 is the first speed mode, the memory management circuit 104 uses the first writing mode to write data and when the speed mode corresponding to the connector 102 is the second speed mode, the memory management circuit 202 uses the second writing mode to write data.

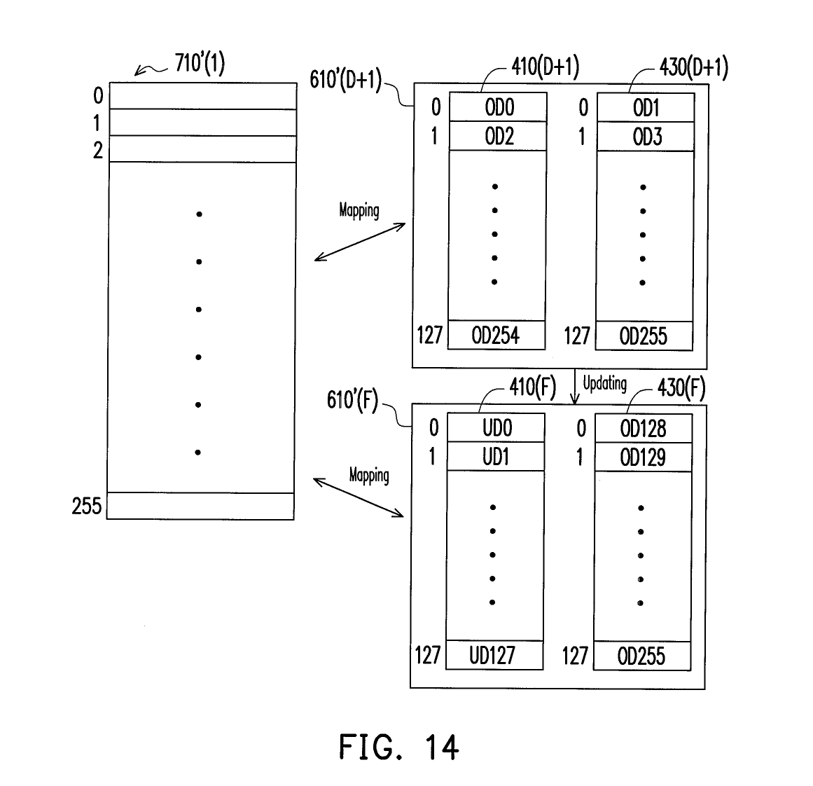

FIG. 14 illustrates an example of executing a write command with the first writing mode according to the second exemplary embodiment of the present invention. In order to explain conveniently, it is assumed that each physical block has 128 physical pages (i.e. 0^{th}˜127^{th} physical pages) and accordingly each logical unit has 256 logical pages (i.e. 0^{th}˜255^{th} logical pages).

Referring to FIG. 14, for example, when the physical unit 610′(D+1) has stored page data OD0˜OD255 belonging to the 0^{th}˜255^{th} logical pages of the logical unit 710′(1) and the host system 1000 is about to store update data belonging to the 0^{th}˜127^{th} logical pages of the logical unit 710′(1), the memory management circuit 202 of the memory controller 104 identifies that the logical unit 710′(1) currently maps the physical unit 610′(D+1), gets the physical unit 610′(F) from the free area 506, arranges the update data into corresponding page data UD0˜UD127 and orderly writes the page data UD0˜UD127 into the physical pages of the physical block 410 (F) of the physical unit 610′(F) (i.e. the operations of opening mother-child blocks shown in FIGS. 6 and 7). In particular, because the physical blocks 410(F) and 430(F) respectively belong to different memory sub-modules, the memory management circuit 202 may move un-updated page data belonging to the logical unit 710′(1) from the physical unit 610′(D+1) to the physical block 430 (F) of the physical unit 610′(F) with the parallel manner.

To be specific, the memory management circuit 202 uses the parallel manner to write the page data UD0 belonging to the 0^{th} logical page of the logical unit 710′(1) into the 0^{th} physical page of the physical block 410(F) and move the page data OD128 belonging to the 128^{th} logical page of the logical unit 710′(1) from the physical unit 610′(D+1) to the 0^{th} physical page of the physical block 430(F).

Subsequently, the memory management circuit 202 uses the parallel manner to write the page data UD1 belonging to the 1^{st} logical page of the logical unit 710′(1) into the 1^{st} physical page of the physical block 410(F) and move the page data OD129 belonging to the 129^{th} logical page of the logical unit 710′(1) from the physical unit 610′(D+1) to the 1^{st} physical page of the physical block 430(F).

By the same token, finally, the memory management circuit 202 uses the parallel manner to write the page data UD127 belonging to the 127^{th} logical page of the logical unit 710′(1) into the 127^{th} physical page of the physical block 410(F) and move the page data OD255 belonging to the 255^{th} logical page of the logical unit 710′(1) from the physical unit 610′(D+1) to the 127^{th} physical page of the physical block 430(F).

And, when the host system 1000 subsequently gives a write command for storing data into another logical unit, because the valid data that is stored in the physical unit 610′(D+1) and belongs to the 128^{th}˜255^{th} logical pages of the logical unit 710′(1) has moved to the physical unit 610′(F), the memory management circuit 202 directly executes the next write command after re-mapping the logical unit 710′(1) to the physical unit 610′(F) in the logical unit-physical unit mapping table (i.e. the physical unit 610′(F) is associated with the data area 504) and associating the physical unit 610′(D+1) with the free area 506. That is, the operations of closing mother-child blocks are performed.

Similarly, in the second exemplary embodiment, when executing next write command, the time for performing the data merging procedure can be reduced by simultaneously moving un-updated valid data during a current write command through the first writing mode. Therefore, when the host system 1000 always stores data having the size that is smaller than a half of the capacity of one physical unit (e.g. the host system 1000 uses the Default Speed Mode to store data), the time for executing a write command can be shortened through the first writing mode.

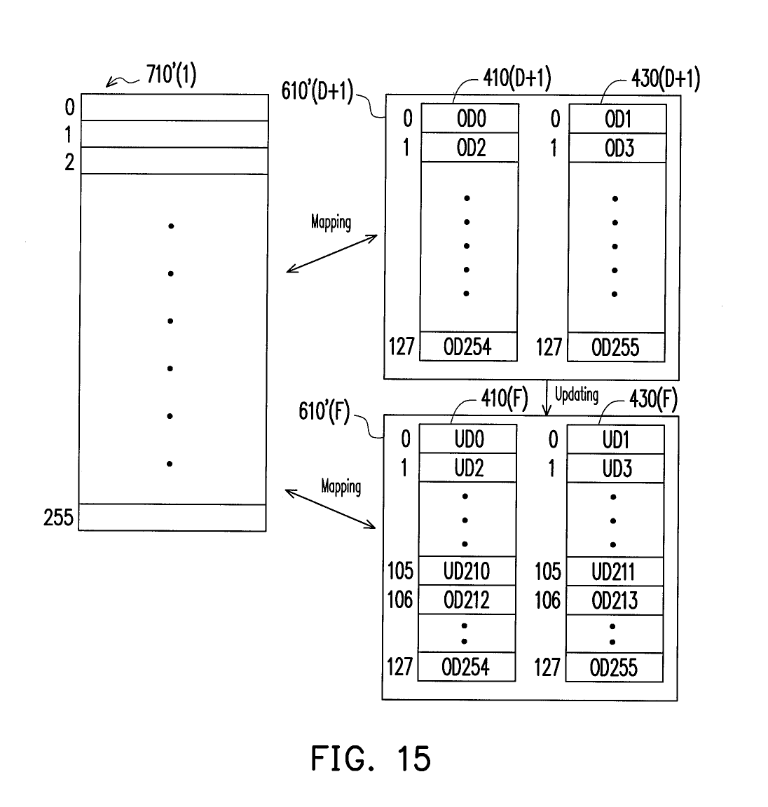

FIG. 15 illustrates an example of executing a write command with the second writing mode according to the second exemplary embodiment of the present invention. In order to explain easily, it is assumed that each physical block has 128 physical pages (i.e. 0^{th}˜127^{th} physical pages) and accordingly each logical unit has 256 logical pages (i.e. 0^{th}˜255^{th} logical pages).

Referring to FIG. 15, for example, when the physical unit 610′(D+1) has stored page data OD0˜OD255 belonging to the 0^{th}˜255^{th} logical pages of the logical unit 710′(1) and the host system 1000 is about to store update data belonging to the 0^{th}˜211^{th} logical pages of the logical unit 710′(1), the memory management circuit 202 of the memory controller 104 identifies that the logical unit 710′(1) currently maps the physical unit 610′(D+1), gets the physical unit 610′(F) from the free area 506, arranges the update data as corresponding page data UD0˜UD211 and orderly writes the page data UD0˜UD211 into the physical pages of the physical blocks 410 (F) and 430(F) of the physical unit 610′(F) (i.e. the operations of opening mother-child blocks shown in FIGS. 6 and 7).

To be specific, the memory management circuit 202 uses the parallel manner to write the page data UD0˜UD1 belonging to the 0^{th}˜1^{st} logical pages of the logical unit 710′(1) into the 0^{th} physical page of the physical block 410(F) and the 0^{th} physical page of the physical block 430(F). That is, during such programming, the page data UD0 belonging to the 0^{th} logical page of the logical unit 710′(1) is written into the 0^{th} physical page of the physical block 410(F) and the page data UD1 belonging to the 1^{st} logical page of the logical unit 710′(1) is written into the 0^{th} physical page of the physical block 430(F).

Subsequently, the memory management circuit 202 uses the parallel manner to write the page data UD2˜UD3 belonging to the 2^{nd}˜3^{rd} logical pages of the logical unit 710′(1) into the 1^{st} physical page of the physical block 410(F) and the 1^{st} physical page of the physical block 430(F).

By the same token, finally, the memory management circuit 202 uses the parallel manner to write the page data UD210˜UD211 belonging to the 210^{th}˜211^{th} logical pages of the logical unit 710′(1) into the 105^{th} physical page of the physical block 410(F) and the 105^{th} physical page of the physical block 430(F).

And, when the host system 1000 subsequently gives a write command for storing data into another logical unit, before executing the write command, the memory management circuit 202 moves valid data belonging to the 212^{th}˜255^{th} logical pages of the logical unit 710′(1) from the physical unit 610′(D+1) to the corresponding physical pages of the physical unit 610′(F), re-maps the logical unit 710′(1) to the physical unit 610′(F) in the logical unit-physical unit mapping table (i.e. the physical unit 610′(F) is associated with the data area 504) and associates the physical unit 610′(D+1) with the free area 506 (i.e. similar to the operations of closing mother-child blocks shown in FIG. 8).

Similarly, in the second writing mode, when the second write mode is applied to write data, continuous logical pages of one logical unit are dispersedly mapped to physical pages belonging to different memory sub-modules. Therefore, when the host system 1000 writes large amounts of data into continuous logical pages, those data can be written with the parallel manner into the physical pages, thereby shortening the time for writing data.

In summary, the data writing method, the memory controller and the memory storage apparatus of the present invention are capable of applying a corresponding data writing mode to write data according to a speed mode applied by a data transmission interface of a host system. Accordingly, a suitable writing mode is selected according to a pattern of writing data by the host system, and thereby the time for executing a write command can be shortened. And, the performance of the memory storage apparatus can be improved. The previously described exemplary embodiments of the present invention have the advantages aforementioned, wherein the advantages aforementioned not required in all versions of the present invention.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A data writing method for writing data into a rewritable non-volatile memory module of a memory storage apparatus, wherein the rewritable non-volatile memory module includes a plurality of physical blocks, each of the physical blocks has a plurality of physical pages arranged with a sequence and the physical blocks are grouped into a plurality of physical units, the data writing method comprises:
configuring a plurality of logical units for mapping to a portion of the physical units, wherein each of the logical units has a plurality of logical pages and a first logical unit among the logical units originally maps to a first physical unit among the physical units;
receiving a command from a host system and obtaining a work frequency according to the command;
switching a speed mode corresponding to the memory storage apparatus to a first speed mode or a second speed mode according to the work frequency;
selecting a first writing mode to write the data into a second physical unit among the physical units when the speed mode is the first speed mode; and
selecting a second writing mode to write the data into the second physical unit among the physical units when the speed mode is the second speed mode.

2. The data writing method according to claim 1, wherein the first speed mode is a default speed mode and the second speed mode is an ultra high speed mode.

3. The data writing method according to claim 1 further comprising:
arranging the data into a plurality of page data, wherein the page data belongs to the first logical unit,
wherein in the first writing mode, the page data is written into the physical pages of one of the physical blocks of the second physical units,
wherein in the second writing mode, the page data is written into the physical pages of a plurality of physical blocks among the physical blocks of the second physical unit.

4. The data writing method according to claim 3 further comprising:
wherein the second physical unit is composed of a first physical block, a second physical block, a third physical block and a fourth physical block,
wherein the step of selecting the first writing mode to write the data into the second physical unit comprises:
writing page data belonging to a 0^{th} logical page of the first logical unit among the page data into a 0^{th} physical page of the first physical block;
writing page data belonging to a 1^{st} logical page of the first logical unit among the page data into a 0^{th} physical page of the second physical block;
moving page data belonging to a m^{th} logical page of the first logical unit among the page data from the first physical unit to a 0^{th} physical page of the third physical block; and
moving page data belonging to a (m+1)^{th} logical page of the first logical unit among the page data from the first physical unit to a 0^{th} physical page of the fourth physical block,
wherein m is calculated according to a formula (1):
m=K/2+1 (1)
wherein K represents the number of the logical pages of the first logical unit.

5. The data writing method according to claim 3,
wherein the second physical unit is composed of a first physical block, a second physical block, a third physical block and a fourth physical block,
wherein the step of selecting the second writing mode to write the data into the second physical unit comprises:
writing page data belonging to a 0^{th} logical page of the first logical unit among the page data into a 0^{th} physical page of the first physical block;
writing page data belonging to a 1^{st} logical page of the first logical unit among the page data into a 0^{th} physical page of the second physical block;
writing page data belonging to a 2^{nd} logical page of the first logical unit among the page data into a 0^{th} physical page of the third physical block; and
writing page data belonging to a 3^{rd} logical page of the first logical unit among the page data into a 0^{th} physical page of the fourth physical block.

6. The data writing method according to claim 3,
wherein the second physical unit is composed of a first physical block and a second physical block,
wherein the step of selecting the first writing mode to write the data into the second physical unit comprises:
writing page data belonging to a 0^{th} logical page of the first logical unit among the page data into a 0^{th} physical page of the first physical block; and
moving page data belonging to a m^{th} logical page of the first logical unit among the page data from the first physical unit to a 0^{th} physical page of the second physical block,
wherein m is calculated according to a formula (0):
m=K/2+1 (1)
wherein K represents the number of the logical pages of the first logical unit.

7. The data writing method according to claim 3,
wherein the second physical unit is composed of a first physical block and a second physical block,
wherein the step of selecting the second writing mode to write the data into the second physical unit comprises:
writing page data belonging to a 0^{th} logical page of the first logical unit among the page data into a 0^{th} physical page of the first physical block; and
writing page data belonging to a 1^{st} logical page of the first logical unit among the page data into a 0^{th} physical page of the second physical block.

8. The data writing method according to claim 1, wherein the step of switching the speed mode corresponding to the memory storage apparatus to the first speed mode or the second speed mode according to the work frequency comprises:
marking a flag to record that the speed mode is the first speed mode or the second speed mode.

9. A memory controller for controlling a rewritable non-volatile memory module, wherein the rewritable non-volatile memory module includes a plurality of physical blocks, and each of the physical blocks has a plurality of physical pages arranged with a sequence, the memory controller comprising:
a host interface, configured to couple to a host system and receive data;
a memory interface, configured to couple to the rewritable non-volatile memory module; and
a memory management circuit, coupled to the memory interface and the host interface,
wherein the memory management circuit is configured to group the physical blocks into a plurality of physical units and configure a plurality of logical units for mapping to a portion of the physical units, wherein each of the logical units has a plurality of logical pages and a first logical unit among the logical units originally maps to a first physical unit among the physical units,
wherein the memory management circuit is further configured to receive a command from the host system and obtain a work frequency according to the command,
wherein the memory management circuit is further configured to switch a speed mode corresponding to the host interface to a first speed mode or a second speed mode according to the work frequency,
wherein the memory management circuit selects a first writing mode to write the data into a second physical unit among the physical units when the speed mode is the first speed mode,
wherein the memory management circuit selects a second writing mode to write the data into the second physical unit among the physical units when the speed mode is the second speed mode.

10. The memory controller according to claim 9, wherein the first speed mode is a default speed mode and the second speed mode is an ultra high speed mode.

11. The memory controller according to claim 9, wherein the memory management circuit is further configured to arrange the data into a plurality of page data, wherein the page data belongs to the first logical unit,
wherein in the first writing mode, the memory management circuit writes the page data into the physical pages of one of the physical blocks of the second physical units,
wherein in the second writing mode, the memory management circuit writes the page data into the physical pages of a plurality of physical blocks among the physical blocks of the second physical unit.

12. The memory controller according to claim 11, wherein the second physical unit is composed of a first physical block, a second physical block, a third physical block and a fourth physical block,
wherein in the first writing mode, the memory management circuit writes page data belonging to a 0^{th} logical page of the first logical unit among the page data into a 0^{th} physical page of the first physical block, writes page data belonging to a 1^{st} logical page of the first logical unit among the page data into a 0^{th} physical page of the second physical block, moves page data belonging to a m^{th} logical page of the first logical unit among the page data from the first physical unit to a 0^{th} physical page of the third physical block and moves page data belonging to a (m+1)^{th} logical page of the first logical unit among the page data from the first physical unit to a 0^{th} physical page of the fourth physical block,
wherein m is calculated according to a formula (1):
m=K/2+1 (1)
wherein K represents the number of the logical pages of the first logical unit.

13. The memory controller according to claim 11, wherein the second physical unit is composed of a first physical block, a second physical block, a third physical block and a fourth physical block,
wherein in the second writing mode, the memory management circuit writes page data belonging to a 0^{th} logical page of the first logical unit among the page data into a 0^{th} physical page of the first physical block, writes page data belonging to a 1^{st} logical page of the first logical unit among the page data into a 0^{th} physical page of the second physical block, writes page data belonging to a 2^{nd} logical page of the first logical unit among the page data into a 0^{th} physical page of the third physical block and writes page data belonging to a 3^{rd} logical page of the first logical unit among the page data into a 0^{th} physical page of the fourth physical block.

14. The memory controller according to claim 11,
wherein the second physical unit is composed of a first physical block and a second physical block,
wherein in the first writing mode, the memory management circuit writes page data belonging to a 0^{th} logical page of the first logical unit among the page data into a 0^{th} physical page of the first physical block and moves page data belonging to a m^{th} logical page of the first logical unit among the page data from the first physical unit to a 0^{th} physical page of the second physical block,
wherein m is calculated according to a formula (1):
m=K/2+1 (1)
wherein K represents the number of the logical pages of the first logical unit.

15. The memory controller according to claim 11, wherein the second physical unit is composed of a first physical block and a second physical block,
wherein in the second writing mode, the memory management circuit writes page data belonging to a 0^{th} logical page of the first logical unit among the page data into a 0^{th} physical page of the first physical block and writes page data belonging to a 1^{st} logical page of the first logical unit among the page data into a 0^{th} physical page of the second physical block.

16. The memory controller according to claim 9, wherein the memory management circuit marks a flag to record that the speed mode is the first speed mode or the second speed mode.

17. A memory storage apparatus, comprising:
a connector, configured to couple to a host system and receive data;
a rewritable non-volatile memory module, having a plurality of physical blocks, wherein each of the physical blocks has a plurality of physical pages arranged with a sequence; and
a memory controller, coupled to the connector and the rewritable non-volatile memory module,
wherein the memory controller is configured to group the physical blocks into a plurality of physical units and configure a plurality of logical units for mapping to a portion of the physical units, wherein each of the logical units has a plurality of logical pages and a first logical unit among the logical units originally maps to a first physical unit among the physical units,
wherein the memory controller is further configured to receive a command from the host system and obtain a work frequency according to the command,
wherein the memory controller is further configured to switch a speed mode corresponding to the connector to a first speed mode or a second speed mode according to the work frequency,
wherein the memory controller selects a first writing mode to write the data into a second physical unit among the physical units when the speed mode is the first speed mode,
wherein the memory controller selects a second writing mode to write the data into the second physical unit among the physical units when the speed mode is the second speed mode.

18. The memory storage apparatus according to claim 17, wherein the first speed mode is a default speed mode and the second speed mode is an ultra high speed mode.

19. The memory storage apparatus according to claim 17, wherein the memory controller is further configured to arrange the data into a plurality of page data, wherein the page data belongs to the first logical unit,
wherein in the first writing mode, the memory controller writes the page data into the physical pages of one of the physical blocks of the second physical units,
wherein in the second writing mode, the memory controller writes the page data into the physical pages of a plurality of physical blocks among the physical blocks of the second physical unit.

20. The memory storage apparatus according to claim 19, wherein the second physical unit is composed of a first physical block, a second physical block, a third physical block and a fourth physical block,
wherein in the first writing mode, the memory controller writes page data belonging to a 0^{th} logical page of the first logical unit among the page data into a 0^{th} physical page of the first physical block, writes page data belonging to a 1^{st} logical page of the first logical unit among the page data into a 0^{th} physical page of the second physical block, moves page data belonging to a m^{th} logical page of the first logical unit among the page data from the first physical unit to a 0^{th} physical page of the third physical block and moves page data belonging to a (m+1)^{th} logical page of the first logical unit among the page data from the first physical unit to a 0^{th} physical page of the fourth physical block,
wherein m is calculated according to a formula (1):
m=K/2+1 (1)
wherein K represents the number of the logical pages of the first logical unit.

21. The memory storage apparatus according to claim 19, wherein the second physical unit is composed of a first physical block, a second physical block, a third physical block and a fourth physical block,
wherein in the second writing mode, the memory controller writes page data belonging to a 0^{th} logical page of the first logical unit among the page data into a 0^{th} physical page of the first physical block, writes page data belonging to a 1^{st} logical page of the first logical unit among the page data into a 0^{th} physical page of the second physical block, writes page data belonging to a 2^{nd} logical page of the first logical unit among the page data into a 0^{th} physical page of the third physical block and writes page data belonging to a 3^{rd} logical page of the first logical unit among the page data into a 0^{th} physical page of the fourth physical block.

22. The memory storage apparatus according to claim 19,
wherein the second physical unit is composed of a first physical block and a second physical block,
wherein in the first writing mode, the memory controller writes page data belonging to a 0^{th} logical page of the first logical unit among the page data into a 0^{th} physical page of the first physical block and moves page data belonging to a m^{th} logical page of the first logical unit among the page data from the first physical unit to a 0^{th} physical page of the second physical block,
wherein m is calculated according to a formula (1):
m=K/2+1 (1)
wherein K represents the number of the logical pages of the first logical unit.

23. The memory storage apparatus according to claim 19, wherein the second physical unit is composed of a first physical block and a second physical block,
wherein in the second writing mode, the memory controller writes page data belonging to a 0^{th} logical page of the first logical unit among the page data into a 0^{th} physical page of the first physical block and writes page data belonging to a 1^{st} logical page of the first logical unit among the page data into a 0^{th} physical page of the second physical block.

24. The memory storage apparatus according to claim 17, wherein the memory controller marks a flag to record that the speed mode is the first speed mode or the second speed mode.
